(19) United States
(12) Patent Application Publication
(10) Pub. No.: US 2012/0101896 A1
(43) Pub. Date: Apr. 26, 2012

(54) Online promotional tool

(76) Inventors: William J. Veeneman, Hudson, WI (US); Kathleen M. Veeneman, Tempe, AZ (US); James R. Mirick, Chaska, MN (US)

(21) Appl. No.: 13/317,587

(22) Filed: Oct. 21, 2011

Related U.S. Application Data
(60) Provisional application No. 61/405,511, filed on Oct. 21, 2010.

(51) Int. Cl. G06Q 30/02

(52) U.S. Cl. 705/14.49

(57) ABSTRACT

An Internet-based marketing service. The marketing service according to embodiments of the invention is designed to link local businesses with local consumers while supporting local causes. In an embodiment, the system includes a processor having non-transitory memory coupled to the processor, a database configured to store data related to the plurality of businesses, a network accessible by the user and operably coupling the processor with the database and a landing page for each of the plurality of businesses, the landing page including a business name, wherein the processor is configured to receive a user-defined area, and to display the landing pages of businesses belonging to the area for the user based on the user-defined area and data stored in the database. In an embodiment, a method of providing community-directed marketing is disclosed. In another embodiment, a method of dynamically generating advertising using a system for community-directed marketing is disclosed.

### RELATED APPLICATION

The present application claims the benefit of U.S. Provisional Application No. 61/405,511 filed Oct. 21, 2010, which is incorporated herein in its entirety by reference.

### FIELD OF THE INVENTION

The present invention relates generally to Internet-based marketing services. More specifically, the present invention relates to marketing and advertising services that link local businesses to local consumers while supporting local causes.

### BACKGROUND OF THE INVENTION

With the recent growth of the Internet, consumers have changed the way they shop. Recent statistics suggest that the Internet has become a key resource for consumers. For example, 78% of women plan their shopping on the web. Further, 68% of shoppers say promotions spur visits to stores. Additionally, 60% of shoppers look for coupons before shopping. Likewise, businesses have changed the way they market to these now-online consumers. Most businesses use the Internet in some capacity to market, sell, or otherwise interact with consumers. And, in some fields, maintaining an online presence is almost a necessity. However, because of some of the obstacles, including cost, technology, and marketing expertise required, it can be prohibitively expensive for small, local businesses to enter the online marketing fray.

Internet websites are housed on computers connected to the Internet. Thus, an initial cost required of businesses wishing to maintain an online presence is the cost of computers, networking equipment, software, and resources to manage the equipment that will house the business' website. This cost is often much more than a small business can afford.

Similarly, the burden of knowing and mastering the Internet technologies or protocols required to create dynamic and engaging, yet simple websites or other customer-facing online interfaces is a severe obstacle to businesses wishing to maintain an online presence. Such businesses would either need to learn these technologies themselves—often outside of their area of expertise—or hire someone that already knows the technologies. Neither option is desirable for most businesses. The burdens of learning a technology restrict business owners from concentrating on their strengths—selling their products or services, and the costs of hiring an expert in Internet programming is often extremely expensive.

Small businesses wishing to maintain an online presence must also master the intricacies of online marketing in order to be successful in their online efforts. Again, this would require independent study and research of what marketing tools work and what don't, or the hiring of an expensive expert in online marketing. Both options are undesirable for the same reasons as described in the Internet technologies problem above. Learning marketing techniques takes away from the business owners' core strengths of selling their products or services, and hiring an expert can be costly.

Further, because of the inherent unruliness of the Internet, consumers looking for information relating to potential purchases are presented with numerous obstacles to overcome before they can gain access to the information they desire. For example, a consumer would need to know the precise name of every potential local business in which a product they might be seeking is carried. This is onerous on consumers and unhelpful to businesses of meager marketing means. After establishing every desired store's name, consumers would need to subsequently visit every store's individual website. In doing so, they will undoubtedly be confronted with myriad different website interfaces. This requires consumers to learn each store's website interface, method of categorization, and website structure. Additionally, consumers are unable to quickly search by any meaningful feature or category, or save various preferences or bookmarked items without doing so on each store's website. These burdens cost consumers valuable time and resources.

Additionally, existing Internet geographic search and retrieval services consider the only formal geography, e.g. city name or zip code, which makes it difficult to highlight the locality of shopping opportunities. For example, a search of merchants that sell “widgets” in “City A” would return exactly that—stores X, Y, Z in City A that sell widgets, with no mention of stores 1, 2, 3 located in adjoining City B that also sell widgets, but may be relatively closer to the consumer despite the city boundary. A second search of stores that sell widgets in City B would be required of the consumer to find these stores. This is a problem for both merchants, who are not linked to nearby consumers, as well as consumers, who undoubtedly need to expend more resources (time, driving distance) finding their desired products.

Further complicating the geographic search problem described above is the continued popularity of search engines generating revenue with ad-based results. For many Internet search engines, continuing the example above, a search of merchants that sell “widgets” in “City A” would return first all paid advertisers related to widgets and City A. Moreover, Internet retailers are often grouped with local businesses. As a result, the local businesses actually selling widgets in City A are faced with staggering costs in order to pay and thus compete in being “found” in a search. Further, local businesses are often faced with additional expense in constantly monitoring the search result rankings with their related technologies in order to keep the respective businesses in the top search results. Such expense and expertise is simply not feasible for small, local brick and mortar businesses.

Thus, there is a need for a streamlined, inexpensive method for local businesses to connect with local consumers via an Internet-based marketing service that houses numerous local stores' websites in a single location.

### SUMMARY OF THE INVENTION

In an embodiment, a system for community-directed marketing accessible by at least one user and promoting the offerings of a plurality of businesses comprises a processor having non-transitory memory coupled to the processor, a database configured to store data related to the plurality of businesses, a network accessible by the user and operably coupling the processor with the at least one user, and a landing page for each of the plurality of businesses, the landing page including a business name, wherein the processor is configured to receive a user-defined area, and to display the landing pages of businesses belonging to the area for the user based on the user-defined area and data stored in the database. In embodiments, landing pages can also include a plurality of business locations and related location descriptions, as well as respective business offering data, and/or coupon data, among other details.

In an embodiment, a method of providing community-directed marketing comprises initiating the method by providing a user with a marketing artifact, receiving a user-defined first area, the first area comprising a geographic area to receive a benefit, receiving a user-defined second area, the second area comprising a geographic area to be patronized by the user, receiving at least one offer for at least one business, the at least one business being located in the second area, publishing, to the user, the at least one offer of the at least one business located in the second area, and recording transaction data from the published at least one offer.

In an embodiment, a method of dynamically generating advertising using a system for community-directed marketing, the system accessible by at least one user and including a processor having non-transitory memory coupled to the processor, a database configured to store data related to the plurality of businesses, a network accessible by the user and operably coupling the processor with the at least one user, and a landing page for each of the plurality of businesses, the landing page including a business name, wherein the processor is configured to receive a user-defined area, and to display the landing pages of businesses belonging to the area for the user based on the user-defined area and data stored in the database comprises receiving, by the processor, at least one piece of business data for use by the user from at least one of the plurality of businesses, updating the database with the at least one piece of business data, and publishing the at least one piece of business data. In embodiments, methods allow businesses to build offers dynamically that respond to current business conditions and can be limited to location used, quantity used, and time period in which the offers can be used. Unlike traditional marketing services, the method of the present embodiment allows businesses to dynamically update their business data with embodiments of the system without having to get authorization or approval from the host system. This allows for extreme flexibility in adapting to market changes, inventory changes, and business need changes, as well as to adapt to transaction history results.

The Internet-based marketing service according to embodiments of the present application substantially meets the aforementioned needs of the industry. The service according to embodiments of the invention is designed to tightly link online marketing to drive local business while at the same time strengthening the local community. The service generally comprises an interactive website housed on a server that is connected to the Internet. The service thus provides an online micro-marketing opportunity for local businesses that utilizes the global reach of the Internet.

The service provides for a dedicated community website for every participating community. Participating businesses within the participating community would then be able to utilize the service's streamlined search function that targets local customers. By engaging with local customers via a global service, local businesses get the same visibility and marketing resources as national chains. Further, local businesses can then exploit fast-changing technology, including mobile coupons and social networking at a low cost and low learning curve to them.

Consumers, including local residents and website visitors, gain one-click access to all relevant local store information, including coupons and event details. Further, customers are able to search by numerous characteristics or categories to gather shopping information. Additionally, consumers are able to acquire businesses' coupons or offers via the website. Ultimately, local consumers are able to maximize their time and resources by utilizing the service and the unique information it provides.

The service utilizes community-directed advertising, which drives local traffic to participating businesses by promoting participating businesses through a community-centric search engine that leverages ease of access and awareness of a single site that hosts all participating businesses. Further, the service's community-directed advertising provides visibility to business listings with a variety of marketing tools, like sponsoring civic institutions communicating to their membership to shop participating businesses, ongoing search engine optimization, enabling cause fundraising by selling marketing artifact that allows purchasers to download special coupons from local businesses, emailing offers from participating businesses to all community residents who sign up with an email address, providing a membership badge to display in the store and on the website of each participating store, thus subsequently strengthening the community connection, donating funds to local civic and educational programs in exchange for promoting the participating businesses, establishing a local and consistent presence on various social networks, and distributing business information and coupons to local residents' home computer, cell phone, or by other means.

A key feature of the service is the searchable landing pages for local businesses. In an embodiment, an individual searchable landing page is defined as a real or dynamically-generated presentation of data in a web browser or other electronic delivery application. Each business is represented by data that drives the presentation of an individual searchable webpage containing that business' detailed listing data. In essence, the landing page acts as the business' online presence in the absence of its own independent website. These landing pages provide external search-engine visibility for database-driven business listings and coupons such that if someone on an external search engine searches for one of the businesses, the engine will return the service's coupon-result page. The landing page contains meta content tags to ensure that the merchant name and other key business-related terms are active for the external search engine.

Another feature of the service is the utilization of social media as exemplified by the “Like” and “Follow” features. After a consumer has placed a search on the service, the website gives the searching consumer the ability to “follow” the service's geographically-specific Facebook, Twitter, or other account. This creates a geographic connection between the consumer and an extension of the service in the form of social media such that the service is able to actively update or post to the consumer future marketing related to the consumer's specific location.

Another feature of the service is the ability to return search results in many different forms. For example, the service can format return result lists for specific communities, local stores in a specific geographic location, and cities with participating stores, among others. Further, the search result listings can be sorted, including by newness, relative distance, age appropriateness, category, or alphabetical store name, among others. This is of great use to the consumer, who can then make purchasing decisions based on this unique information.

With the flexibility of the aforementioned search, merchants can be included in search results in a city as formally defined per their address, included within a locale or neighborhood within a city or region, which may be only informally defined or identified or may be ad-hoc, and/or included in a larger region or market area, which may be informally defined or identified. Likewise, consumers can then find merchants' offers and coupons through geographic searches at several levels of specificity, from neighborhood up through regions, find offers and coupons related to local events and festivals, and further refine searches for types of items or age-appropriateness. All of this is done without the clutter of paid advertisements or having to wade through results for online companies who are not physically located in the respective community being searched. Further, embodiments provide information on offers and coupons related to local businesses, rather than selling the offers themselves, in contrast to the sales websites of existing marketing services. In embodiments, a coupon can be a discount, incentive, or special offer to the user that is not sold to a user but readily accessible to use.

Another feature of the service is an interactive map that details participating geographic locations and the associated businesses. The map allows for state and regional zooming so that specific geographic areas can be viewed. Such a feature is valuable not only to consumers who live in a certain location, but those who may be traveling to that location as well. Purchasing or travel decisions can then be made with this information.

Another feature of the service is the ability of the consumer to sign up for multiple mailing groups in a single sign-up page. This data is stored in a database such that queries can operate on the inputted data to uniquely identify the different emails that should be sent to the consumer.

Another feature of the service is the GO MAX CARD (GMC) program. GMC enables local businesses to geographically target their offers to the local community and to change the offers as often as business needs dictate. Likewise, consumers utilizing the GMC program gain the benefit of knowledge of the latest offers as dictated by the freshness (and potentially unique or high-value offers) of merchants' inventory. The program operates in a cycle of assembling merchants and offers, selling and distributing cards to the consumer, the consumer acquiring coupons and subsequently purchasing items, and GMC tracking and analyzing participation and effectiveness.

Core to the GMC program is the issuance of secure marketing artifacts, such as access codes or code-containing cards that, when interfaced with the GMC system, provide code owners access to special coupons and other offers that are contained within a secure web site. Embodiments are not limited to the above-mentioned codes or cards, but are referred to here as codes for simplicity. The codes can be acquired by, for example, in certain embodiments, signing up online or by purchasing a card. For each code acquisition, a fee is charged that is paid to the sponsoring institution who is engaged in fundraising by promoting the program. Thus, the sponsoring institution is benefitted and good is driven. Accordingly, secure access codes can issue to each merchant, group, or organization to track and report its sales. Assigned codes can allow for varying levels of authentication for sale and use, such that certain codes can allow access to local businesses and other codes can allow for broader access, such as to regional or national businesses. Codes can be issued in a variety of ways, from online, to text codes on mobile devices, email, and print. In one embodiment, the acquirer of the code is invited to go to the program web site and enter their personal email address, zip code, password or other secure information to activate their account. Personalizing also establishes what level of service the consumer purchased in terms of access to broader geographic areas of the program. Further, in one embodiment, issuance of the codes is through a set of printed cards that can be distributed to the organization members for the purpose of selling and purchasing such cards. In other embodiments, the offers or codes may be distributed via other printed materials or digitally on an electronic device.

A major benefit of the GMC program is the utilization of program use tracking. Because each secure access code acquirer is requested to “personalize” the access code they have acquired, the program can utilize this information and tailor offers to each member of a specified community. Use of all access codes is reported to the issuing institution to track against reported sales. Further, once a code is personalized, the GMC program can track use when, for example in one embodiment, the acquirer logs into the website to learn of the offers and coupons available and to then obtain those offers if desired.

Detailed, product-level, consumer-level, and merchant-level tracking is also available through the GMC program. As each offer/coupon is selected by a consumer, the system automatically encodes the offer to track its use. This tracking can capture who, when, and what offer is selected and the participating business at which it is used. Further, tracking can be itemized down to the individual item purchased. Additionally, each offer/coupon can have information on the acquirer, the sponsoring institution who sold the program, merchant identification, and offer, date, and delivery type—digital, print, etc. In another embodiment, the program offers the incentive of a second reward for the personalization of the offer to the acquirer in which the offer is collected at the point of sale and returned GMC for additional reward to the participating institution. As a result, the participating consumer can be given a personal incentive or enrolled in a particular contest.

From a merchant perspective, GMC offers a highly flexible system in which merchants are able to continually adjust their offerings. In one embodiment, the system counts and limits the number of offers printed or accessed, sets a limited time expiration date based upon date accessed, limits the number of offers per acquirer code, sends special offers to the code user based upon the needs of the business, continuously changes offers based upon the marketing decisions of each business, and tracks and reports use, which can be reported by business, day, or user, among others. Therefore, merchants are benefitted.

From a consumer perspective, GMC provides for an opt-in communication service such that consumers can be on the cutting edge of merchant offers and communication. Further, consumers are kept well-informed of expiration dates and program terms. For example, upon a business issuing a new offer, the consumer owning the card, access code, or other marketing artifact can be notified of the new offer via the communication service.

In another embodiment, businesses can be identified as being a part of a conceptual affiliation instead of a pure geographic identity. For example, in areas around college campuses that may be expansive and not easily defined by geography, businesses can be identified by affiliation with the college or near the college area. For example, there may be several adjacent neighborhoods in which students wish to shop that all encompass a locally-known, informally defined area, and are easily represented by such an affiliation. In other embodiments, affiliations can be local, informal communities, elementary, middle, secondary, or other schools, or electoral districts, for example.

The above summary of the invention is not intended to describe each illustrated embodiment or every implementation of the present invention. The figures and the detailed description that follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 is a flowchart of system architecture, according to an embodiment.

FIG. 2 depicts a business landing page, according to an embodiment.

FIG. 3 depicts a search results page having a plurality of business landing pages, according to an embodiment.

FIG. 4A is a flowchart of a method of marketing utilizing a marketing artifact, according to an embodiment.

FIG. 4B is a detailed flowchart of a portion of the elements of FIG. 4A, according to an embodiment.

FIG. 5 is a flowchart of a method of marketing using cards, according to an embodiment.

FIG. 6 is a flowchart of a method of marketing, according to an embodiment.

FIG. 7 is a flowchart of a method of marketing, according to an embodiment.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE DRAWINGS

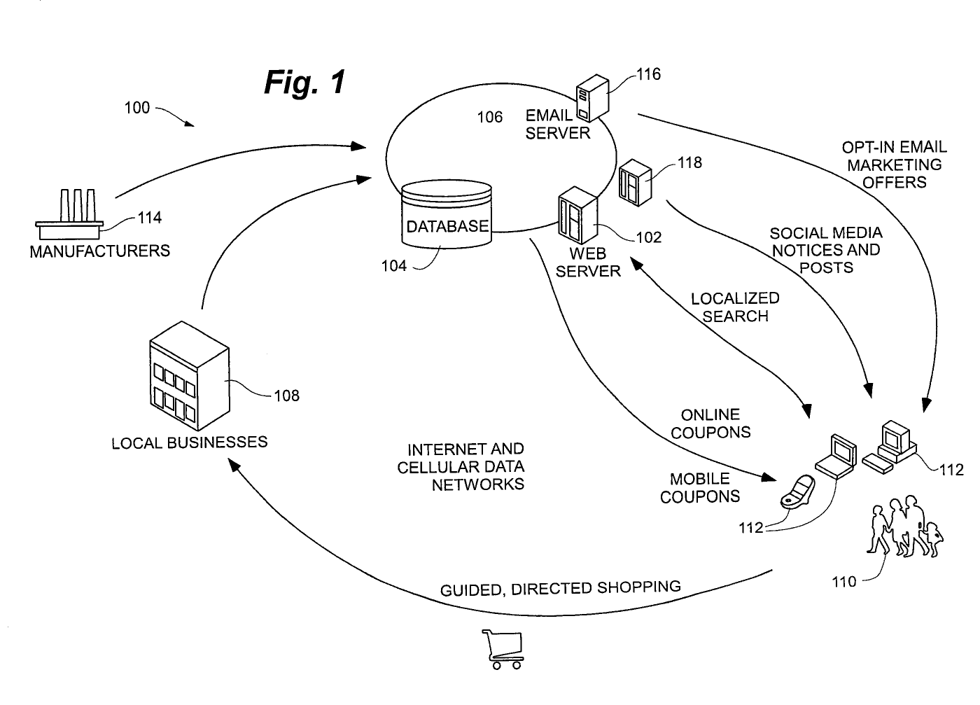

Embodiments relate to systems and methods for community-directed marketing for promoting the offerings of businesses. Referring to FIG. 1, marketing system 100 is depicted. Embodiments of marketing system 100 generally include server 102, database 104, network 106, businesses 108, and access by users 110 via devices 112. Optionally, marketing system 100 can include manufacturers 114, email server 116, and social media interface server 118.

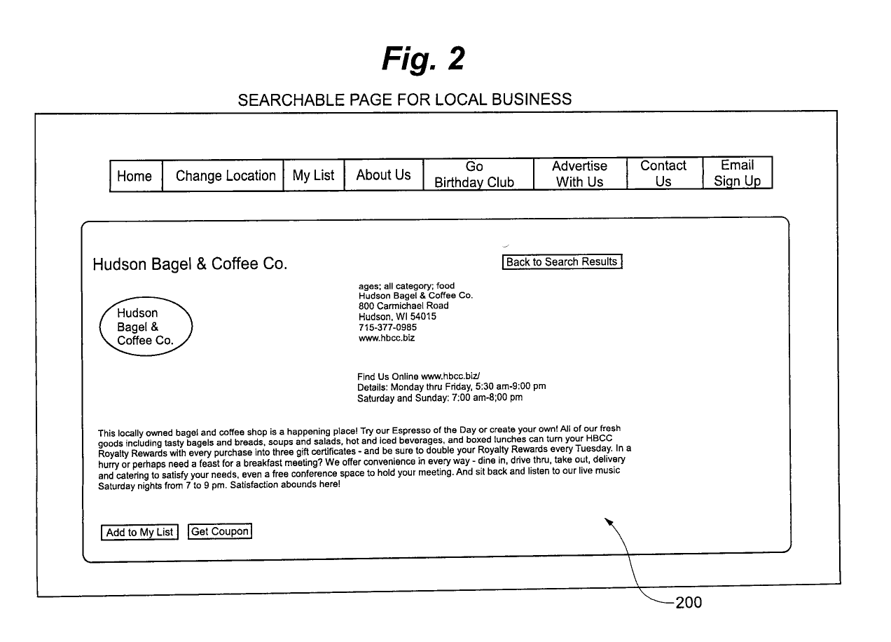

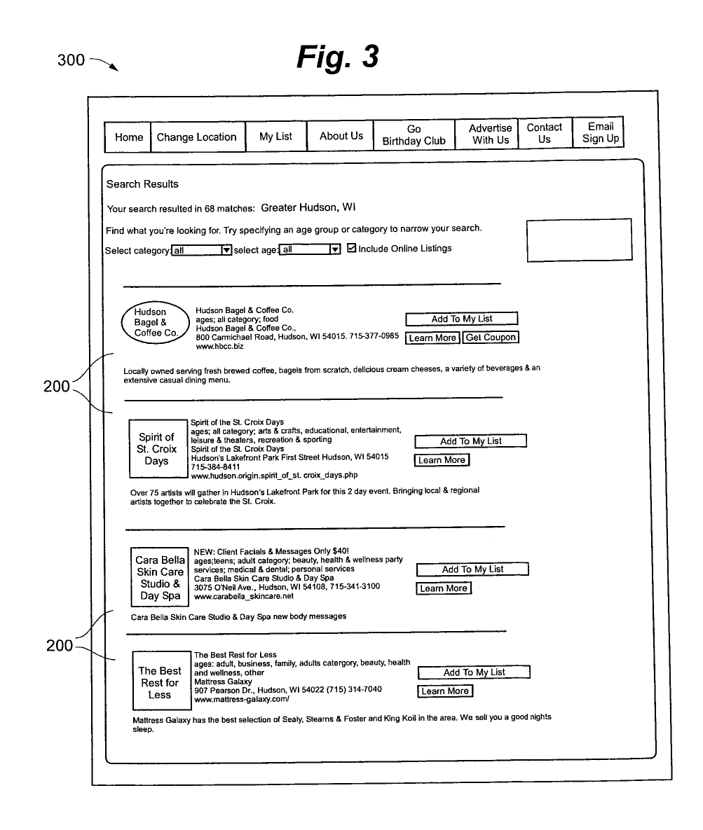

Server 102, in an embodiment, comprises a processor having non-transitory memory coupled to the processor. The processor is configured to access and store data in database 104, as well as to receive data from businesses 108 and manufacturers 114, as well as users 110. As depicted, the data can be transmitted and received along network 106, as will be described. Non-transitory memory allows the processor to run the appropriate algorithms. In an embodiment, server 102 is a web server allowing for the display of various web pages to users 110. In an embodiment, the web page can be a landing page for each of the plurality of businesses, as depicted in FIGS. 2-3.

Referring again to FIG. 1, database 104 can be any kind of organized collection of data. Database 104 is configured to store data related to the plurality of businesses as well as related to users 110. The data can therefore be business name data, sale offering data, coupon data, as well as demographic, social, or economic information of the user, for example. Data can also be related to various transactional data such as transacting user, delivery type, selling institution, or offer executed, for example. In an embodiment, database 104 is housed within server 102. In another embodiment, database 104 is accessible to server 102 along network 106.

Network 106 is any collection of appropriately linked hardware and software components configured to transport data. For example, in embodiments, network 106 can be a wired twisted pair, coaxial cable, Ethernet, or optical fiber network. In other embodiments, network 106 can be a wireless network such as a wireless LAN or cellular network. Network 106 operably couples the processor of server 102 with users 110 such that the network is accessible by users 110 to transmit and receive data. In an embodiment, network 106 operably couples server 102 with database 104. Additionally, businesses 108 and/or manufacturers 114 are coupled to server 102 via network 106. In the optional embodiments having email server 116 and social media server 118, network 106 is further configured to connect these components with server 102 and users 110, as depicted in FIG. 1

By agreeing to market using marketing system 100, businesses 108 are coupled to network 106 and thus system 100. Businesses 108 are coupled to network 106, and thereby server 102, in order to transmit and receive business, transaction, and user data. Business data is transmitted to network 106 from businesses 108 for storage by database 104. Likewise, transaction and user data can be transmitted to businesses 108 from server 102 along network 106 for use in marketing.

Users 110 typically comprise the customers or potential customers of businesses 108. Users 110 access network 106 via devices 112. Devices 112 are any electronic computing device capable of accessing data. For example, devices 112 can comprise a cell phone, laptop computer, desktop computer, tablet, or any other suitable device. In an embodiment, users 110, via devices 112, access web pages presented by server 102 related to data of businesses 108. Users 110, via devices 112, are also capable of transmitting user-defined preferences to server 102. For example, an individual user 110 can transmit a user-defined area in which the user 110 patronizes businesses 108. In sum, guided, direct shopping is a goal of users 110 via system 100.

In embodiments, manufacturers 114 access network 106 and thereby server 102 similar to businesses 108. In embodiments, email server 116 provides directed email services to users 110 as part of marketing system 100. In embodiments, social media server 118 provides social media services to users 110 as part of marketing system 100.

Referring to FIG. 2, a business landing page 200 is depicted, according to an embodiment. In an embodiment, as depicted, an individual searchable landing page is a real or dynamically-generated presentation of data in a web browser or other electronic delivery application. Business landing page 200 is an individual searchable webpage containing an individual business' detailed listing data. The detailed listing data can include the name of the business, the location, phone number, business website, hours, logo, business description, sale or offer data, or coupon data, for example. Effectively, landing page 200 acts as the business' online presence in the absence of its own independent website. Landing pages 200 provide external search-engine visibility for database-driven business listings. In an embodiment, landing page 200 contains meta content tags to ensure that the merchant name and other key business-related terms are active for an external search engine.

Referring to FIG. 3, a search results page 300 having a plurality of business landing pages 200 is depicted, according to an embodiment. Landing pages 200 for multiple businesses are presented to the user in a single web page, as depicted in FIG. 3. In operation, a user 110 defines an area in which to search for businesses. The area in which the user wishes to search is relayed to server 102. Server 102 utilizes its processor and coupled non-transitory memory to interface with database 104, such that the appropriate data is retrieved from database 104. Database 104 data is formatted and displayed in search results page 300. Search results page 300 is thus displayed to user 110.

In an embodiment, the user-defined area is a geographic area. The geographic area could be as elementary as a city, town, or county. However, the geographic area is more effectively defined as a sub-community of the city, town, or county that doesn't have discrete boundary lines; for example, a neighborhood within a city. In an embodiment, user 110 can stipulate business categories or product categories to further refine the search. In embodiments, the user-defined area is scalable to return greater or fewer search results, depending on the scale of the searched area. Further, because the user-defined areas are most effectively defined along non-traditional boundaries, businesses can belong to multiple areas.

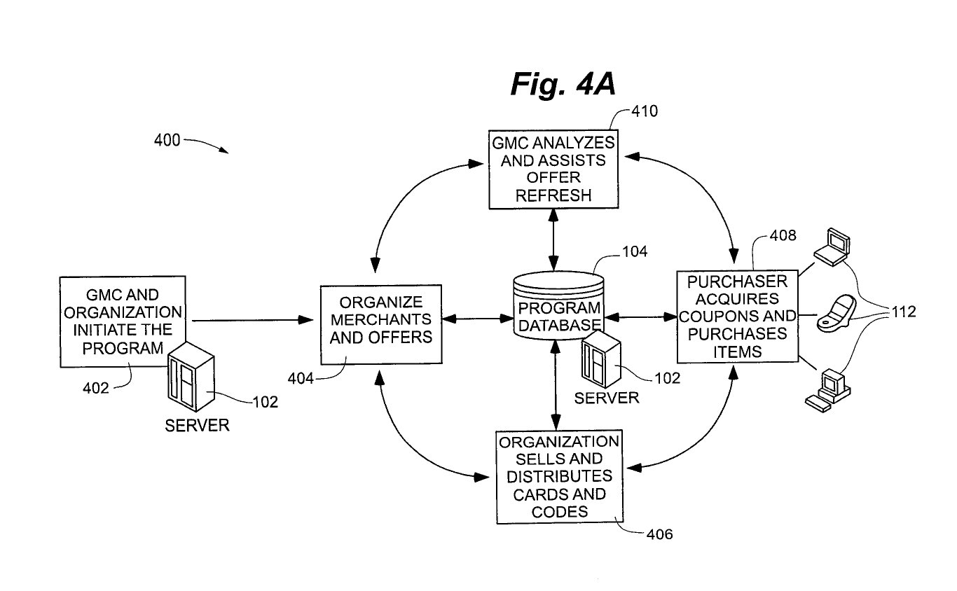

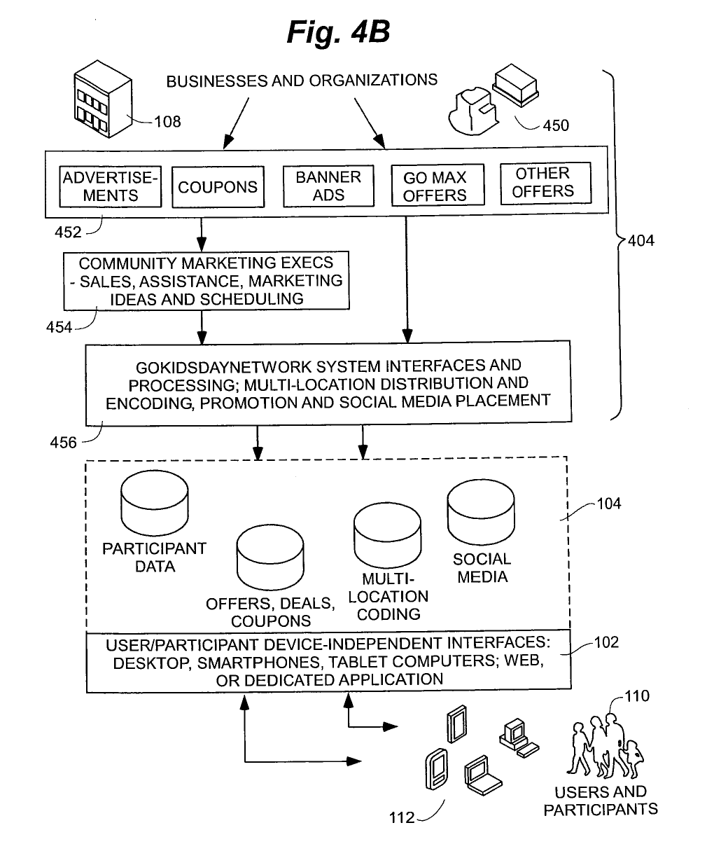

Referring to FIG. 4A, a flowchart of a method of marketing 400 utilizing a marketing artifact is depicted, according to an embodiment. At 402, the method is initiated. In an embodiment and as depicted in FIG. 4A, initialization is done through the accessing of server 102 with an appropriate program registration request. For example, a school, here the selling organization, may request from server 102 that the marketing program be set up for their school.

Merchants and offers are organized by, in an embodiment, marketing system 100, at 404. As described above with respect to marketing system 100, business data can be assembled from businesses 108, in an embodiment. Referring to FIG. 4B, a detailed flowchart of the operation of 404 and the relation to the other elements of FIG. 4A is further depicted.

Businesses 108 and organizations 450 are organized at 404, depicted as a portion of FIG. 4B. Advertisements, coupons, banner advertisements, marketing offers, and other offers of 452 are all tools provided to businesses 108 and organizations 450 desiring marketing services. Community marketing executives of 454 provide sales, marketing, scheduling, and other assistance to the businesses 108 and organization 450 utilizing the tools of 452. The coordination of the services provided at 454 and the tools of 452 are implemented at 456. This can include, for example, interfacing with the system, such as the landing pages 200 described above, multi-location distribution and encoding, promotion, and social media placement.

The implemented tools and accompanying data of 456 are relayed to database 104. In an embodiment, database 104 can be as depicted in FIG. 4B, as a plurality of discrete databases. For example, discrete databases can be configured to store, respectively, participant data, offers, deals, and coupon data, multi-location coding data, and social media data. In another embodiment, a single database 104 is configured to store all participant data, offers, deals, and coupon data, multi-location coding data, and social media data. Similarly, server 102 or a plurality of similar servers 102 provide the user or participant device-independent interfaces to the aforementioned data. As in FIG. 1 and as will be described further in FIG. 4A, the data is accessible to users 110 via devices 112.

Referring again to FIG. 4A, at 406, the selling organization sells and distributes the marketing artifacts set up as part of the marketing program for their respective organization. In an embodiment, the marketing artifact can be a card. In another embodiment, the card can be virtual and accessed via a computer or other electronic device. In another embodiment, the marketing artifact is an access code.

At 408, devices 112 allow users 110 who have purchased cards, codes, or other marketing artifacts, to acquire coupons and purchase items from merchants providing offers as part of 404. These coupons and offers for sale are only available to users 110 who have purchased the artifacts of 406.

At 410, transaction data is analyzed based on the available offers of 404 and executed transactions of 408. At 410, offer refresh is offered to the participating respective merchants such that inventory offers remain fresh and locally appropriate. Any refreshed or changed offers are thus transmitted to users 110 via devices 112, and can be subsequently purchased at 408.

As depicted, the elements of 404, 406, 408, and 410 are interfaceable with the respective neighboring element in order to provide a flexible, useful method of marketing 400. For example, the number and type of merchants and offers that are available as organized at 404 are interfaced to the selling organization at 406 in order to appropriately sell the marketing artifacts.

As appropriate, the elements 404, 406, 408, and 410 interface with server 102 and database 104 when needed. In embodiments, server 102 and database 104 are, as depicted, the server and database of FIG. 1 in marketing system 100. In other embodiments, server 102 and database 104 can be independent, discrete servers and databases.

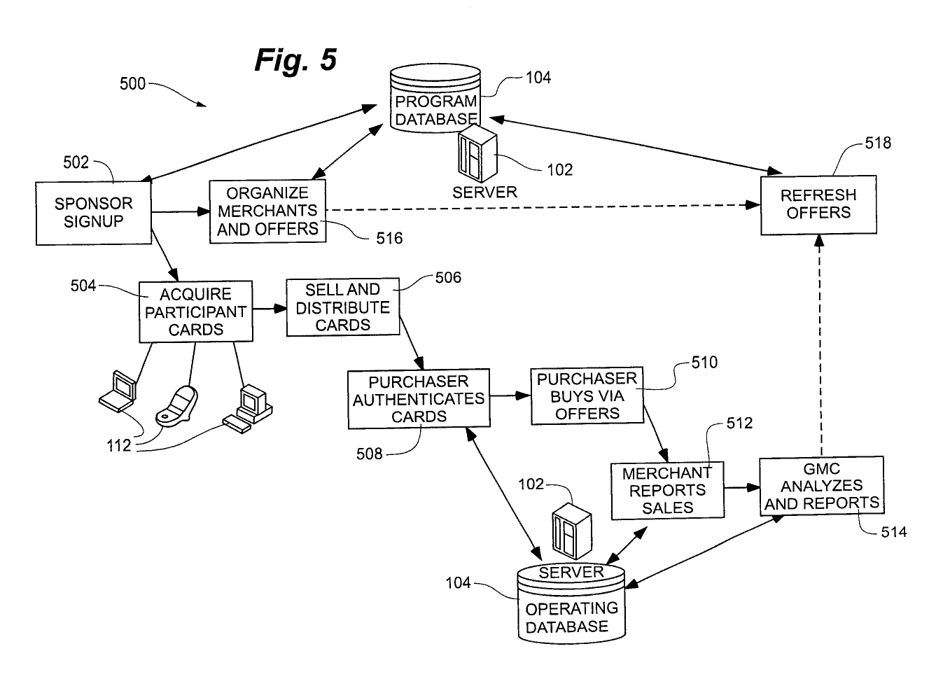

Referring to FIG. 5, a flowchart of a method of marketing 500 using cards is depicted, according to an embodiment. At 502, a sponsor signs up in order to initiate the method 500. The sponsor signup at 502 is interfaced with server 102 and database 104.

At 504, participant cards are acquired by the sponsor. Such acquisition can be by access devices 112, as depicted in FIG. 5. In an embodiment, the card can be virtual and accessed via a computer or other electronic device. In another embodiment, the marketing artifact is an access code. In other embodiments, the marketing artifact is a physical card.

Concurrent with or prior to the sponsor acquiring participant cards at 504, merchants and offers are organized at 516. Merchant and offer data transmitted to server 102 and database 104.

At 506, the cards are sold and distributed. Cards are typically sold by representative members of the sponsoring institution of 502. Card purchasers will typically buy the cards for not only the promised offers for sale by the organized merchants of 516, but for the charitable benefit to the sponsoring institution.

At 508, the card purchaser authenticates the card. Typically, this is done via an interface to server 102 and database 104. In an embodiment, the card purchaser is invited to go to the system web site and enter their personal email address, zip code, password or other secure information to activate their account. Personalizing also establishes what level of service the consumer purchased in terms of access to broader geographic areas of the program.

At 510, the card purchaser buys via one or more offers provided to them. In various embodiments, the card purchaser buys from multiple merchants. Multiple card purchasers can thereby purchase from multiple merchants.

At 512, the selling merchant reports sales to server 102, which is subsequently stored in database 104. The reporting of sales at 512 is attached with information such as the card purchaser, sponsoring institution, merchant identification, and offer, sale, and delivery type, for example.

At 514, this sales and transaction data is accessed from database 104 via server 102. At 514, the data can be aggregated, analyzed, or otherwise summed or evaluated.

Via interface 518, dynamically-refreshing offers can be initiated and implemented by participating merchants. After the analyzing and reporting of 514, such data or reports are transmitted to merchants in order to refresh the published offers. With this data, businesses can continually calibrate their offerings. For example, the number of offers printed or accessed can be counted in order to limit future offers. Or, a limited time expiration date based on the date accessed by card purchasers can be implemented. Alternatively, the offer can be changed based on the needs or desires of the business. As depicted via 516, 518, and 514, this refreshing of offers can be initiated solely by the merchant via server 102 and database 104, without input or evaluation from the hosting system.

In embodiments, server 102 and database 104 are, as depicted, the server and database of FIG. 1 in marketing system 100. In other embodiments, server 102 and database 104 can be independent, discrete servers and databases.

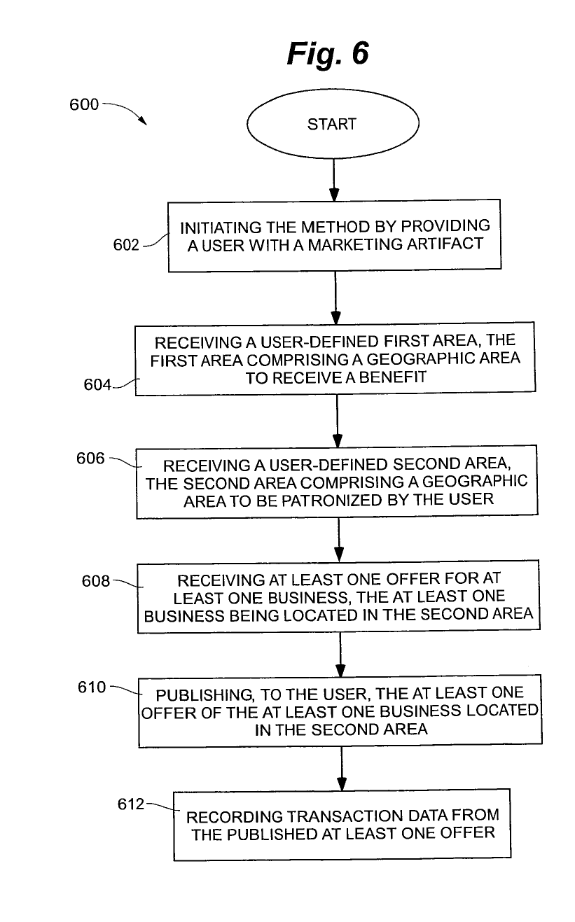

Referring to FIG. 6, a method 600 of providing community-directed marketing is depicted as a flowchart, according to an embodiment.

At 602, method 600 is initiated by providing a user with a marketing artifact. In an embodiment, the marketing artifact can be a card and initiating the method is through a sale of the card by a selling institution. In another embodiment, the card can be virtual and accessed via a computer or other electronic device. In another embodiment, the marketing artifact is an access code.

At 604, a user-defined first area is received. The first area comprises a geographic area to receive a benefit. Such a benefit can be the amount of the sale of the card, for example.

At 606, a user-defined second area is received. The second area comprises a geographic area to be patronized by the user. Such an area will have stores and businesses the user will subsequently shop at. Note that both first and second geographic areas are user-defined, which allows for flexibility in the method 600 for both the user and the distributer of the marketing artifact; for example, the selling institution, in an embodiment. Further, the first area and the second area can comprise the same area or overlapping areas. This is a likely occurrence when, for example, the marketing artifact is sold by a school to a parent living in the same school district. The parent is likely to patronize the geographic area of the school district and also define the benefit to a school in the school district. In an embodiment, demographic, social, or economic information of the user can also be received in order to further tailor the marketing to the user.

At 608, at least one offer for at least one of the businesses is received, where the business is appropriately located in the second area, the patronizing area.

At 610, the at least one offer of the at least one business located in the second area is published to the user. In an embodiment, the publishing of 610 can be displaying the offer on the landing page of the business. In another embodiment, the publishing of 610 can be by pushing the offer to a mobile device of the user. Effectively, method 600 thereby offers published information related to offers of the at least one business, but does not provide a method of selling the offer itself.

At 612, transaction data from the published at least one offer is recorded. In embodiments, the transaction data can include user data, delivery type data, selling institution data, or offer data, as well as basic sale data. In an embodiment, a future offer can be limited based on the recorded transaction data. For example, if a merchant or business only wants 100 offers to be redeemed as defining an offer limit, the recorded transaction data can be checked against the number of offers redeemed. Subsequently, the offer can be removed once the offer limit is reached. In an embodiment, the recorded transaction data can be aggregated, summed, or otherwise combined and subsequently analyzed. In another embodiment, the analyzed transaction data or raw transaction data can be transmitted to the selling merchant or business.

In an embodiment, a second offer from the at least one business located in the second area is received. Subsequently, the second offer can be published. In another embodiment, the second offer is an update to the original offer. In this way, businesses can dynamically update their offerings without evaluation and action by the hosting system.

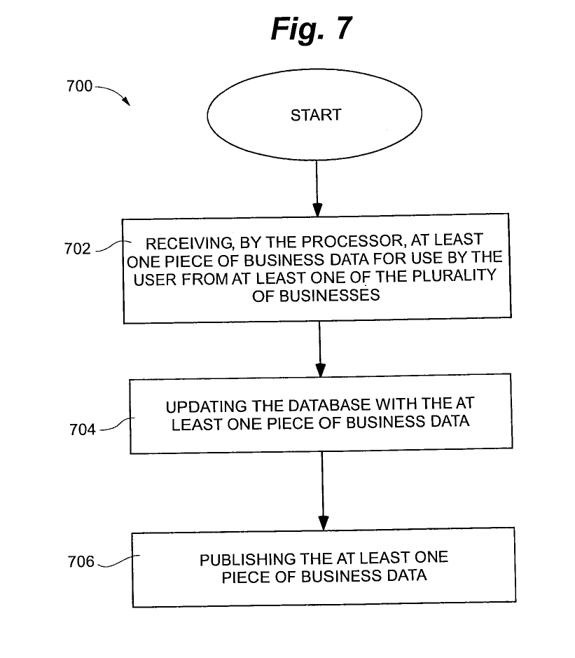

Referring to FIG. 7, a method 700 of dynamically generating advertising using a system for community-directed marketing is depicted as a flowchart. In an embodiment, method 700 is implemented by a system accessible by at least one user and includes a processor having non-transitory memory coupled to the processor, a database configured to store data related to the plurality of businesses, a network accessible by the user and operably coupling the processor with the database, and a landing page for each of the plurality of businesses, the landing page including a business name, wherein the processor is configured to receive a user-defined area, and to display the landing pages of businesses belonging to the area for the user based on the user-defined area and data stored in the database. Method 700 allows for businesses to dynamically update their offerings without evaluation and action by the hosting system. Effectively, this allows businesses to keep their inventory offers fresh and locally appropriate.

At 702, at least one piece of business data for use by the user from at least one of the plurality of businesses is received by the processor. The business data could include an offer for sale, or a coupon, or a new product offering, for example.

At 704, the database is updated with the at least one piece of business data previously received at 702. The processor transmits the appropriate commands to the database via the operably coupling network in order to store the business data.

At 706, the at least one piece of business data is published to the user. In an embodiment, publishing the at least one piece of business data can be displaying the at least one piece of business data on the landing page of the business. In another embodiment, publishing the at least one piece of business data can be pushing the at least one piece of business data to a mobile device of the user.

In an embodiment, prior to receiving the at least one piece of business data at 702, method 700 can prompt at least one of the plurality of businesses for business data. For example, prior to Valentine's Day, the system implementing method 700 can transmit a message or otherwise interface with one or more of the plurality of businesses and ask if any of the businesses would like to promote a Valentine's Day offer or coupon.

In an embodiment, method 700, as implemented by the above-described system, and specifically the portion interfacing with businesses to transmit business data (which is subsequently received at 702) is password protected. In this way, businesses have direct access to their respective landing pages and can therefore dynamically update their offerings without evaluation and action by the hosting system, as the data is trusted via the password protection. In other embodiments, other security keys or handshaking can be used.

Various embodiments of systems, devices and methods have been described herein. These embodiments are given only by way of example and are not intended to limit the scope of the invention. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the invention.

Persons of ordinary skill in the relevant arts will recognize that the invention may comprise fewer features than illustrated in any individual embodiment described above. The embodiments described herein are not meant to be an exhaustive presentation of the ways in which the various features of the invention may be combined. Accordingly, the embodiments are not mutually exclusive combinations of features; rather, the invention may comprise a combination of different individual features selected from different individual embodiments, as understood by persons of ordinary skill in the art.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims for the present invention, it is expressly intended that the provisions of Section 112, sixth paragraph of 35 U.S.C. are not to be invoked unless the specific terms “means for” or “step for” are recited in a claim.

1. A system for community-directed marketing accessible by at least one user and promoting the offerings of a plurality of businesses, the system comprising:
a processor having non-transitory memory coupled to the processor;
a database configured to store data related to the plurality of businesses;
a network accessible by the user and operably coupling the processor to the at least one user; and
a landing page for each of the plurality of businesses, the landing page including a business name;
wherein the processor is configured to receive a user-defined area, and to display the landing pages of businesses belonging to the area for the user based on the user-defined area and data stored in the database.

2. The system of claim 1, wherein data related to the plurality of businesses is originally organized by a system representative.

3. The system of claim 1, wherein the network is a plurality of individual networks.

4. The system of claim 1, wherein the user-defined area is a geographic area.

5. The system of claim 1, wherein the user-defined area is scalable.

6. The system of claim 1, wherein an individual business belongs to multiple areas.

7. The system of claim 1, wherein the landing page is embedded with metadata.

8. The system of claim 1, wherein the landing page further comprises business offering data.

9. The system of claim 1, wherein the landing page further comprises coupon data.

10. A method of providing community-directed marketing, the method comprising:
initiating the method by providing a user with a marketing artifact;
receiving a user-defined first area, the first area comprising a geographic area to receive a benefit;
receiving a user-defined second area, the second area comprising a geographic area to be patronized by the user;
receiving at least one offer for at least one business, the at least one business being located in the second area;
publishing, to the user, the at least one offer of the at least one business located in the second area; and
recording transaction data from the published at least one offer.

11. The method of claim 10, wherein the marketing artifact is a card and initiating the method is through a sale of the card by a selling institution.

12. The method of claim 11, wherein the card is virtual.

13. The method of claim 10, wherein the marketing artifact is an access code.

14. The method of claim 10, wherein the first area and the second area comprise the same geographic area.

15. The method of claim 10, further comprising limiting a future offer based on the recorded transaction data.

16. The method of claim 10, further comprising receiving from the user at least one of demographic, social, or economic information of the user.

17. The method of claim 10, further comprising analyzing the recorded transaction data.

18. The method of claim 10, further comprising transmitting the recorded transaction data to the at least one business.

19. The method of claim 10, wherein transaction data includes at least one of user data, delivery type data, selling institution data, or offer data.

20. The method of claim 10, further comprising:
receiving a second offer from the at least one business located in the second area; and
publishing, to the user, the second offer.

21. The method of claim 20, wherein the second offer is an update to the original at least one offer.

22. A method of dynamically generating advertising using a system for community-directed marketing, the system accessible by at least one user and including a processor having non-transitory memory coupled to the processor, a database configured to store data related to the plurality of businesses, a network accessible by the user and operably coupling the processor to the at least one user, and a landing page for each of the plurality of businesses, the landing page including a business name, wherein the processor is configured to receive a user-defined area, and to display the landing pages of businesses belonging to the area for the user based on the user-defined area and data stored in the database, the method comprising:
receiving, by the processor, at least one piece of business data for use by the user from at least one of the plurality of businesses;
updating the database with the at least one piece of business data; and
publishing the at least one piece of business data.

23. The method of claim 22, wherein publishing the at least one piece of business data includes displaying the at least one piece of business data on the landing page of the business.

24. The method of claim 22, wherein publishing the at least one piece of business data includes pushing the at least one piece of business data to a mobile device of the user.

25. The method of claim 22, wherein the portion of the system accessed by the plurality of businesses is password-protected.

26. The method of claim 22, further comprising, prior to receiving the at least one piece of business data, prompting at least one of the plurality of businesses for business data.

27. A system for community-directed marketing accessible by at least one user and promoting the offerings of a plurality of businesses, the system comprising:
a processor having non-transitory memory coupled to the processor;
a database configured to store data related to the plurality of businesses;
a network accessible by the user and operably coupling the processor to the at least one user; and
a landing page for each of the plurality of businesses, the landing page including a business name;
wherein the processor is configured to receive a user-defined area, and to display the landing pages of businesses belonging to the area for the user based on the user-defined area and data stored in the database;
and wherein the user-defined area is based on an affiliation.
